(19) United States
(12) Patent Application Publication
(10) Pub. No.: US 2009/0287519 A1
(43) Pub. Date: Nov. 19, 2009

(54) System and Method for Equipment Management

(76) Inventor: Matt Jennings, Ham Lake, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/466,966

(22) Filed: May 15, 2009

Related U.S. Application Data
(60) Provisional application No. 61/053,555, filed on May 15, 2008.

(51) Int. Cl. G06Q 10/00; G06Q 50/00; G06F 17/30

(52) U.S. Cl. 705/7; 705/29; 705/21; 707/104.1; 707/E17.044

(57) ABSTRACT

A method for managing equipment may include operating one or more equipment units, tracking operating data for the one or more equipment units, tracking equipment service data for the one or more equipment units, communicating the operating data and the equipment service data to a database, maintaining the operating data and the equipment service data at the database, operating one or more point of sale interfaces for processing customer orders, communicating customer order data from the point of sale interfaces to the database, maintaining customer order data at the database, and calculating estimated service dates for one or more of the equipments units. The calculation of estimated service dates may be based on the operating data, the equipment service data, and the customer order data.

### FIELD OF THE INVENTION

The present disclosure relates to a system and method for equipment management. More particularly, the present disclosure relates to a system and method for predicting when equipment is likely to fail or require service.

### BACKGROUND

Effective operation of a restaurant depends upon functional operation of many pieces and/or types of equipment. Accordingly, when a piece of equipment fails, restaurant operations are often disrupted. Such disruption may result in significant service delays and/or inability to fulfill customer orders. Traditionally, prevention of such equipment failure includes premature maintenance and/or replacement of equipment and/or the components thereof. This type of remedy, however, is less than ideal because premature maintenance and/or replacement results in increased service costs and under-utilizes the equipment.

A need thus exists for a method of predicting when equipment is likely to fail or require service such that overall maintenance costs are minimized and service is performed before equipment failure.

### BRIEF SUMMARY OF THE INVENTION

Systems and methods for equipment management are provided. More particularly, systems and methods for predicting when equipment units are likely to fail or require service are provided.

A method for managing equipment may include operating one or more equipment units, tracking operating data for the one or more equipment units, tracking equipment service data for the one or more equipment units, communicating the operating data and the equipment service data to a database, maintaining the operating data and the equipment service data at the database, operating one or more point of sale interfaces for processing customer orders, communicating customer order data from the point of sale interfaces to the database, maintaining customer order data at the database, and calculating estimated service dates for one or more of the equipments units. The calculation of estimated service dates may be based on the operating data, the equipment service data, and the customer order data.

An equipment management system may include one or more equipment units, one or more point of sale interfaces configured to process customer orders, one or more user interfaces configured to receive equipment service data, a database for storing system information, the database being in electronic communication with one or more of the equipment units such that equipment operating data is stored to the database, one or more of the point of sale interfaces such that customer order information is stored to the database, and one or more of the user interfaces such that equipment service data is stored to the data, and a central processor operatively associated with the database and including software configured to calculate estimated service dates, the calculations being based on the equipment operating data, customer order data, and equipment service data.

While multiple embodiments are disclosed, still other embodiments will become apparent to those skilled in the art from the following detailed description, which shows and describes illustrative embodiments of the invention. As will be realized, the system and method are capable of modifications in various obvious aspects, all without departing from the spirit and scope of the invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 is a block diagram illustrating the inputs and outputs of a equipment management system in accordance with one embodiment.

FIG. 2 is a block diagram illustrating an equipment management system in accordance with one embodiment.

FIG. 3 is a block diagram illustrating the tracking of point of sale data in accordance with one embodiment.

FIG. 4 is a block diagram illustrating the tracking of equipment service data in accordance with one embodiment.

### DETAILED DESCRIPTION

### A. Overview

A system and method for equipment management is provided. More particularly, a system and method for predicting when equipment is likely to fail or require service is provided. In one embodiment, the system and method may include tracking equipment operating data, point of sale (“POS”) data, and equipment service data. On the basis of this information, the system and method may generate reports detailing, for example, when equipment units are likely to fail or require service.

In some embodiments, the system and method of the present disclosure may predict when equipment is likely to fail or require service by monitoring or tracking equipment operating data, POS data, and equipment service data. For purposes of this description, equipment operating data may refer to any data related to the operation of an equipment unit. For purposes of this description, POS data may refer to any data related to the sale of food and/or beverages to a restaurant customer. For the purposes of this description, the term “restaurant” may refer to an entity having a single site or an entity having a plurality of sites. For purposes of this description, equipment service data may refer to any data related to repair and/or maintenance of equipment and/or the components thereof.

In some embodiments, the system and method may be used by restaurants to, for example, prevent disruption of restaurant operation. For example, a restaurant experiencing frequent equipment breakdown resulting in service disruption may use the system and method to schedule for equipment service such that unplanned service disruptions may be avoided. In some embodiments, the system and method may further be used by restaurants to, for example, maximize utilization of their equipment and/or the components thereof. For example, a restaurant that conducts maintenance on certain types of equipment prematurely can use the system and method to schedule for equipment maintenance such that equipment utilization may be maximized and such that unnecessary costs are reduced or eliminated.

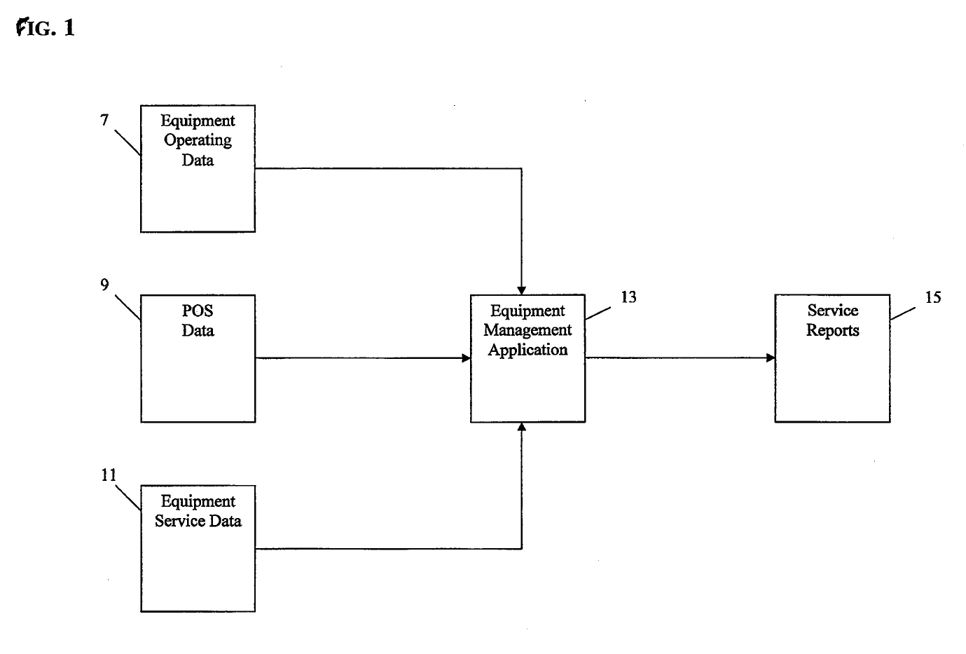

FIG. 1 illustrates one embodiment of a system 5 for predicting when equipment is likely to fail or require service. As shown equipment operating data 7, POS data 9, and equipment service data 11 may serve as inputs to an equipment management application 13. The equipment management application 13 may issue reports 15 detailing, for example, when an equipment unit is likely to fail or require service.

### B. System Configuration

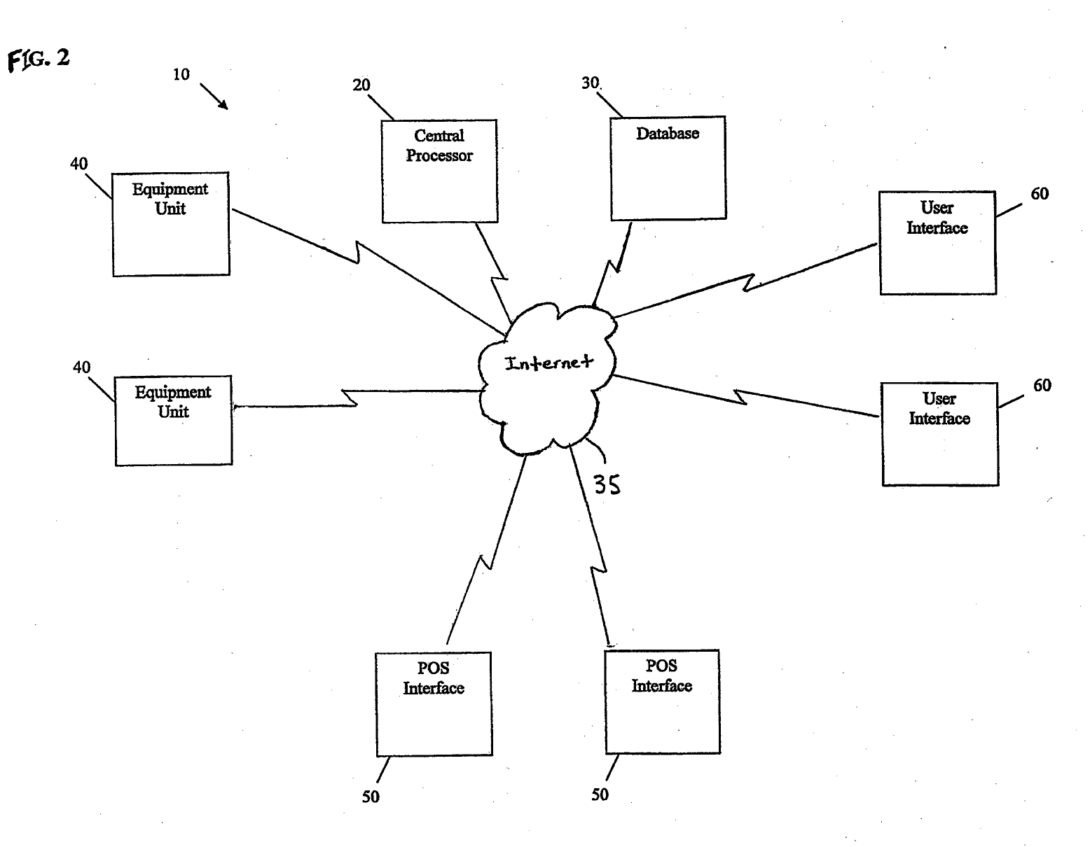

As shown in FIG. 2, an equipment management system 10 is provided. In one embodiment, the system 10 may comprise a central processor 20, located at a central location, one or more databases 30 to store system data, and a plurality of equipment units 40 located at a plurality of restaurant locations. In one embodiment, one or more of the equipment units 40 are equipped with means to communicate with the central processor 20 and database 30 over a communications network 35, such as the Internet. The equipment units 40 may be located at different locations, at the same locations, or a mix thereof. Additionally, in one embodiment, the system may comprise a plurality of point of sale (“POS”) interfaces 50 located at a plurality of restaurant locations, each equipped with means to communicate with the central processor 20 and database 30 over the network 35. In a further embodiment, the system 10 may comprise one or more user interfaces 60 located at one or more restaurant locations. In one embodiment, user interfaces 60 may be used by users of the system to enter system data. While the system is described with respect to an embodiment wherein the central processor 20 is at a location remote from the equipment units 40, it is to be appreciated that the central processor 20 may alternatively be provided at a location of the equipment units 40.

The central processor 20 may be any computer known to those skilled in the art, including standard attachments and components thereof (e.g., a disk drive, hard drive, CD player or network server that communicates with a CPU and main memory, a sound board, a keyboard and mouse, and a monitor). The central processor 20 may include software programs or instructions that process requests and responses from a user of the system 10. These software programs or instructions send information to and receive information from the database 30 (described below), perform compilation and storage functions, and generate reports that may be accessed by users of the system 10. The software may be software applications commercially sold and normally used by those skilled in the art or may be one or more specific applications coded for use with the system disclosed herein.

The system 10 may also include one or more databases 30 for storing system data. The databases 30 may be of any type generally known in the art. In one embodiment, the databases 30 may be integral to the central processor 20. In an alternative embodiment, the databases 30 may be accessible to the central processor through the network 35 or other suitable communication link. In one embodiment, the database 30 comprises a plurality of database servers, some of which are integral to the central processor 20, and some of which are located remotely from the central processor 20. In some embodiments, as will be discussed in greater detail below, the databases 30 may store any information directly and/or indirectly relating to use, maintenance, and/or repair of restaurant equipment.

As shown, the system 10 may include one or more equipment units 40. In some embodiments, equipment units 40 may comprise any equipment used in a restaurant which requires periodic maintenance and/or is susceptible to breakdown and/or failure, such as for example, commercial appliances, heating and cooling equipment, sanitation equipment, and/or the components thereof. For example, in one embodiment, equipment units 40 may include, without limitation, fryers, coffee brewers, microwaves, stoves, grills, mixers, steamers, ice makers, beverage dispensers, filters, dishwashers, coolers, freezers, and/or components thereof.

In some embodiments, the system 10 may include one or more POS interfaces 50. POS interfaces 50 may be any computer or computer systems used in the restaurant industry to process customer orders. In one embodiment, the POS interfaces 50 comprise a central processor unit and main memory, an input/output interface for communicating with various databases, files, programs, and networks (such as the Internet). The POS interfaces 50 may also have a monitor or other screen device and an input device, such as a keyboard, a mouse, or a touch sensitive screen.

In some embodiments, the system 10 may include one or more user interfaces 60. User interfaces 60 may be any computer or computer systems. In one embodiment, the user interfaces 60 may comprise a central processor unit and main memory, an input/output interface for communicating with various databases, files, programs, and networks. The user interfaces 60 may also have a monitor or other screen device and an input device, such as a keyboard, a mouse, or a touch sensitive screen. In some embodiments, user interfaces 60 may be provided in one or more restaurant sites having equipment units 40. Alternatively, user interfaces 60 may be provided in any location accessible to users of the system 10. In one embodiment, users of the system may access user interfaces 60 to view system information, input system information, and/or exchange data with the central processor.

### C. Equipment Operating Data

Prior to implementation of the system and method, or as part of implementation of the system and method, general equipment unit information may be provided and stored to the databases 30. The general equipment unit information may include site information relating to all the sites where a restaurant has equipment, including site location, identification of equipment at the site, and any other relevant site information. In a further embodiment, a restaurant's equipment units 40 may be inventoried and an identifier created for each equipment unit 40 to give it a trackable identity. In some embodiments, the equipment unit identifiers may also be stored to the databases 30.

In some embodiments, equipment operating data may be provided to the system manually by a user of the system 10 or automatically (i.e., without manual input by a user). Generally, equipment operating data may include any information related to the operation of an equipment unit, or the components thereof. More specifically, in one embodiment, equipment operating data may include data related to the number of uses, type of use, duration of use, and/or operating conditions of equipment units 40, or the components thereof. For example, equipment operating data may include the number of batches of food which have been prepared in a given commercial fryer (“fryer cycles”). An exemplary system and method for tracking the number of fryer cycles which have occurred in a commercial fryer is described in U.S. application Ser. No. 12/060,705, entitled Fry Cycle Monitoring, the contents of which are incorporated herein by reference. Additionally, for example, equipment operating data may include the number of compressor cycles which have occurred for a given refrigeration unit. A further example of equipment operating data may include the brew temperature at which a commercial coffee brewer has been brewing at. Alternatively, equipment operating data may include any data related to the number of uses, type of use, duration of use, and/or operating conditions of equipment units.

In some embodiments, the system may automatically track equipment operating data. In one embodiment, automatic tracking of operating data may include enabling electronic communication between one or more equipment units 40 and the network 35, receiving operating data over the network 35 at the central processor 20, and storing the operating data to the database 30.

In some embodiments, equipment units 40 may be equipped with communications capabilities in order to automatically tracking operating data. In one embodiment, one or more equipment units 40 may have data ports through which operating data may be communicated to the network 35. Alternatively, in some embodiments, electrical components may be coupled to equipment units 40 such that operating data may be communicated electronically to the network 35. An exemplary configuration of electrical components coupled to an equipment unit is provided in U.S. application Ser. No. 12/060,705, entitled Fry Cycle Monitoring, the contents of which are incorporated herein by reference.

In a further embodiment, equipment units 40 may comprise intelligent equipment. For purposes of the present disclosure, intelligent equipment refers to equipment that has been manufactured to communicate over a network, such as the Internet, and is equipped built-in resident sensors.

In some embodiments, operating data may be provided to the system manually by a user of the system 10. In one embodiment, users of the system 10 may access user interfaces 60 and input operating data. The entered data may then be received over the network 35 at the central processor 20 and stored to the database 30.

### D. POS Data

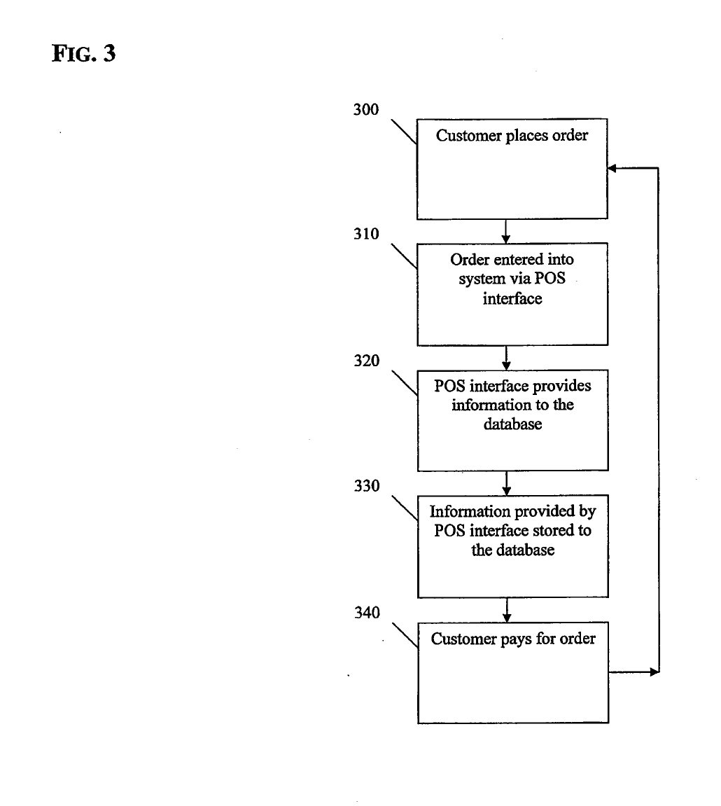

FIG. 3 is a flow chart illustrating the tracking of POS data in accordance with one embodiment. Typically, the process may be initiated by a customer placing an order with a restaurant employee (block 300). An order may, generally, comprise one or more food and/or beverage items. The one or more food and/or drink items may have an associated “size” that corresponds to a predetermined quantity of food or beverage. For example, a customer may order a “medium” french fry, which may, for example, correspond to 6 oz. of french fries. Alternatively, for example, a customer may order a “medium” coffee, which may, for example, correspond to 12 fl. oz. of coffee. The restaurant employee may then enter the order into the system via the POS interface 50 (block 310). Alternatively, the customers themselves may enter orders into the system via a POS interface 50.

After an order is entered into the system, in some embodiments, the POS interface 50 provides information to the database (block 320). Provision of such information may be in real time or may, in some embodiments, be delayed, such as reporting of occurred events on a timed basis. In some embodiments, the POS interface 50 provides all information relating to the customer order. In one embodiment, if the customer order contains one or more food and/or beverage products (a “sale event”), for each sale event, the POS interface 50 provides any or all of the size (e.g., small, medium, large, etc.), type (e.g., french fries, hamburger, coffee, softdrink, etc.), and date/time of the order. The information provided by the POS interface 50 may then be stored to the databases 30 (block 330). In some embodiments, the system saves all sale event information in the databases 30 such that the system accumulates all sale event history. The customer may then conclude the order (block 340) by paying for the order. After conclusion of the order, another customer order may be placed (block 300).

### E. Equipment Service Data

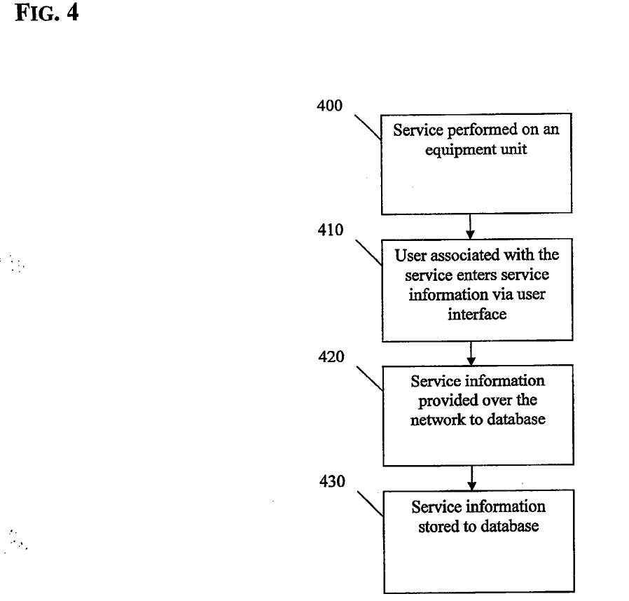

FIG. 4 is a flow chart illustrating the tracking of the equipment service data, according to one embodiment. In some embodiments, service data may include any information related to service, maintenance, and/or repair performed on an equipment unit and/or the components thereof. In one embodiment, for example, the service information may include an equipment identifier, type of service performed, and/or date/time of the service.

In some embodiments, maintenance, repair, or any other type of service may be performed on an equipment unit and/or the components thereof (block 400). In one embodiment, the service provider may be a restaurant employee. In alternative embodiments, the service provider may be an individual or entity external to the restaurant. In some embodiments, a user associated with the service may access a user interface 60 and enter the service information (block 410). Alternatively, any authorized user of the system 10 may access a user interface 60 and enter the service information. The entered service information may then be provided to the database 30 over the network (block 420). After service information has been provided, the service information may be stored to the database 30 and associated with the equipment unit serviced (block 430). According to one embodiment, the system 10 saves all such service information in the databases 30 such that the system accumulates all service information history.

### F. Estimated Service Dates

In some embodiments, on the basis of the stored equipment unit operating data, POS data, and equipment service data, the system 10 may calculate estimated service dates. For purposes of the present disclosure, the estimated service date may refer to a date on which a particular equipment unit and/or the components thereof is likely to require maintenance and/or repair.

### G. Report Generation

In some embodiments, on the basis of the stored equipment unit operating data, POS data, and equipment service data, the system 10 may generate service reports.

In some embodiments, service reports may comprise information relating to service of a restaurant's equipment units (“service information”). In one embodiment, service information may include any information related to future service which may be required on equipment units and/or the components thereof, such as for example, estimated service dates. Additionally, in some embodiments, service information may include any historical information related to past maintenance, service, and/or repair of one or more equipment units and/or the components thereof.

In some embodiments, the service reports may include service information for one or more of a restaurant's equipment units. In one embodiment, the service reports may include service information for equipment units identified by the system 10 as having an estimated service date that is approaching.

In some embodiments, the service reports may be generated and distributed on a periodic basis, such as daily, weekly, or monthly, for example. In an alternative embodiment, reports may be generated and distributed upon the occurrence of a triggering event, such as for example, when a time until the estimated service date of one or more equipment units falls below a predetermined threshold.

Although the present invention has been described with reference to preferred embodiments, persons skilled in the art will recognize that changes may be made in form and detail without departing from the spirit and scope of the invention.

We claim:

1. A method for managing equipment comprising:
operating one or more equipment units;
tracking operating data for the one or more equipment units;
tracking equipment service data for the one or more equipment units;
communicating the operating data and the equipment service data to a database;
maintaining the operating data and the equipment service data at the database;
operating one or more point of sale interfaces for processing customer orders;
communicating customer order data from the point of sale interfaces to the database;
maintaining customer order data at the database; and
calculating estimated service dates for one or more of the equipments units, wherein calculation of the estimated service dates is based on the operating data, the equipment service data, and the customer order data.

2. The method of claim 1, further comprising generating service reports including the estimated service dates.

3. The method of claim 2, wherein the service reports include estimated service dates for equipment units having estimated service dates over a selected period.

4. The method of claim 2, wherein generating the service reports comprises generating the service reports on a periodic basis.

5. The method of claim 1, wherein generating the service reports comprises generating the service reports in response to an occurrence of a triggering event.

6. The method of claim 5, wherein time until an estimated service date falling below a predetermined threshold defines the triggering event.

7. The method of claim 1, wherein any or all of the operating data, the equipment service data, and the customer order information are communicated remotely to the database.

8. The method of claim 1, wherein the equipment units comprise commercial fryers.

9. A equipment management system comprising:
one or more equipment units;
one or more point of sale interfaces configured to process customer orders;
one or more user interfaces configured to receive equipment service data;
a database for storing system information, the database being in electronic communication with one or more of the equipment units such that equipment operating data is stored to the database, one or more of the point of sale interfaces such that customer order information is stored to the database, and one or more of the user interfaces such that equipment service data is stored to the data; and
a central processor operatively associated with the database and including software configured to calculate estimated service dates, the calculations being based on the equipment operating data, customer order data, and equipment service data.

10. The equipment management system of claim 9, the software being further configured to generate service reports including the estimated service dates.

11. The equipment management system of claim 10, wherein the service reports include estimated service dates for equipment units having estimated service dates over a selected period.

12. The equipment management system of claim 10, the software being further configured to generate the service reports on a periodic basis.

13. The equipment management system of claim 10, the software being further configured to generate the service reports in response to an occurrence of a triggering event.

14. The method of claim 13, wherein time until an estimated service date falling below a predetermined threshold defines the triggering event.

15. The equipment management system of claim 9, wherein the equipment operating data comprises information related to any or all of number of uses, type of use, duration of use, and operating conditions of the equipment units, or components thereof.

16. The equipment management system of claim 9, wherein at least one of the equipment units is at a location remote from a location of the central processor.

17. The method of claim 1, wherein any or all of the operating data, the equipment service data, and the customer order information are communicated remotely to the database.

18. The method of claim 1, wherein the equipment units comprise commercial fryers.
